(19) United States
(12) Patent Application Publication
(10) Pub. No.: US 2018/0217237 A1
(43) Pub. Date: Aug. 2, 2018

(54) OPTIMIZED PIEZOELECTRIC DRIVER FOR LIDAR BEAM DEFLECTION

(71) Applicant: QUALCOMM Incorporated, San Diego, CA (US)

(72) Inventor: Linda Irish, San Diego, CA (US)

(21) Appl. No.: 15/234,801

(22) Filed: Aug. 11, 2016

(51) Int. Cl. G01S 7/481; G01S 17/88; G01S 17/08; G02B 26/08

(52) U.S. Cl. CPC G01S 7/4817; G02B 26/08; G01S 17/08; G01S 17/88

(57) ABSTRACT

Aspects of the disclosure are related to a method for providing a driving signal to a piezoelectric element within a Lidar, comprising: determining a phase difference between a phase of the driving signal and a phase of cantilever vibration to be kept constant, the cantilever comprising the piezoelectric element and a fiber optic cable; generating a periodic signal while a difference between a phase of the periodic signal and the phase of cantilever vibration is kept constant at the determined phase difference with a phase-locked loop; amplifying the periodic signal into the driving signal; and supplying the driving signal to the piezoelectric element to cause the cantilever to vibrate, wherein light emitted from the fiber optic cable which deflects as part of the vibrating cantilever creates a scanning pattern.

### FIELD

The subject matter disclosed herein relates to electronic devices, and more particularly to methods, apparatuses, and systems for measuring the distance to an object using light.

### BACKGROUNDS

A Lidar (also LIDAR, LiDAR, or LADAR, portmanteau of “light” and “radar”) is a remote sensing technology that measures distance by illuminating a target with a laser and analyzing the reflected light. The ability to accurately range the distance to the objects in the immediate environment is important for many mobile applications, such as indoor mapping and navigation, enhanced photography, or computer vision, etc.

A Lidar may consist of two subsystems—a beam steering element and a range finder. The beam steering element may steer the projected laser beam to create a scanning pattern. And the range finder may convert the reflected light from the object being scanned into information about the distance to different parts of the object based on such measurements and/or techniques as pulsed Time of Flight, phase shift Time of Flight, or coherent detection, etc. The scanning laser may be emitted from a fiber optic cable threaded through a piezoelectric element (e.g., a piezo ceramic tube). The piezoelectric element may be tube-shaped and may be fixed at one end and free at the other end. The fiber optic cable may be fixed to the free end of the piezoelectric element, while the free end of the fiber optic cable may be extended further from the free end of the piezoelectric element by a predetermined length. As such, a fixed-free vibrating cantilever system may be created. The length of the free fiber optic cable extension outside the piezoelectric element and other physical properties of the fiber optic cable may determine the resonant frequency of the cantilever.

By applying suitable driving signals, the piezoelectric element may be driven to vibrate. When the piezoelectric element is driven to vibrate at the resonant frequency of the cantilever, the cantilever may be excited in the resonance mode. In other words, small vibrations at the base of the cantilever may be amplified and the tip of the fiber optic cable may vibrate with a large amplitude. Moreover, the motion of the tip of the fiber optic cable may be controlled with suitable driving signals applied to the piezoelectric element to implement a desired scanning pattern. Optics may be used to collect the laser exiting from the tip of the fiber optic cable and condition it for projection.

The piezoelectric element may be a rigid structure difficult to bend. Electrically actuating the piezoelectric element for two-dimensional movement (e.g., in orthogonal X- and Y-axes) may require a driving signal with a relatively high voltage. A high quality factor (Q factor) of resonance of the cantilever is required to obtain enough displacement at the tip of the fiber optic since the piezoelectric element itself deflects by only a few microns. The high quality factor means that to get the maximum deflection, the vibration frequency of the cantilever—and thus the driving signal frequency—has a small tolerable margin of error. In other words, the driving signal frequency cannot deviate from the resonant frequency of the cantilever by more than a few Hertz (Hz). Moreover, the harmonics in the driving signal must be sufficiently low as not to excite multiple resonant modes.

### SUMMARY

One aspect of the disclosure is related to a method for providing a driving signal to a piezoelectric element within a Lidar, comprising: determining a phase difference between a phase of the driving signal and a phase of cantilever vibration to be kept constant, the cantilever comprising the piezoelectric element and a fiber optic cable; generating a periodic signal while a difference between a phase of the periodic signal and the phase of cantilever vibration is kept constant at the determined phase difference with a phase-locked loop; amplifying the periodic signal into the driving signal; and supplying the driving signal to the piezoelectric element to cause the cantilever to vibrate, wherein light emitted from the fiber optic cable which deflects as part of the vibrating cantilever creates a scanning pattern.

Another aspect of the disclosure is related to a device, comprising: a Lidar comprising a cantilever comprising a piezoelectric element and a fiber optic cable; a memory; and a processor coupled to the memory, the processor to: determine a phase difference between a phase of a driving signal and a phase of cantilever vibration to be kept constant, generate a periodic signal while keeping a difference between a phase of the periodic signal and the phase of cantilever vibration constant at the determined phase difference with a phase-locked loop, amplify the periodic signal into the driving signal, and supply the driving signal to the piezoelectric element to cause the cantilever to vibrate, wherein light emitted from the fiber optic cable which deflects as part of the vibrating cantilever creates a scanning pattern.

Yet another aspect of the disclosure is related to a device for providing a driving signal to a piezoelectric element within a Lidar, comprising: means for determining a phase difference between a phase of the driving signal and a phase of cantilever vibration to be kept constant, the cantilever comprising the piezoelectric element and a fiber optic cable; means for generating a periodic signal while a difference between a phase of the periodic signal and the phase of cantilever vibration is kept constant at the determined phase difference with a phase-locked loop; means for amplifying the periodic signal into the driving signal; and means for supplying the driving signal to the piezoelectric element to cause the cantilever to vibrate, wherein light emitted from the fiber optic cable which deflects as part of the vibrating cantilever creates a scanning pattern.

Still another aspect of the disclosure is related to a non-transitory computer-readable medium comprising code which, when executed by a processor, causes the processor to perform a method for providing a driving signal to a piezoelectric element within a Lidar, comprising: determining a phase difference between a phase of the driving signal and a phase of cantilever vibration to be kept constant, the cantilever comprising the piezoelectric element and a fiber optic cable; generating a periodic signal while a difference between a phase of the periodic signal and the phase of cantilever vibration is kept constant at the determined phase difference with a phase-locked loop; amplifying the periodic signal into the driving signal; and supplying the driving signal to the piezoelectric element to cause the cantilever to vibrate, wherein light emitted from the fiber optic cable which deflects as part of the vibrating cantilever creates a scanning pattern.

### BRIEF DESCRIPTION OF THE DRAWINGS

FIG. 1 is diagram illustrating an example device with which embodiments of the disclosure may be practiced.

FIG. 2 is a block diagram illustrating an example an example drive system.

FIG. 3 is a block diagram illustrating an example signal generation module.

FIG. 4 is a flowchart illustrating an example method for providing a driving signal to a piezoelectric element within a Lidar.

### DETAILED DESCRIPTION

Embodiments of the disclosure are related to apparatuses, systems, and methods for generating and supplying a driving signal to a vibrating cantilever comprising a piezoelectric element within a Lidar.

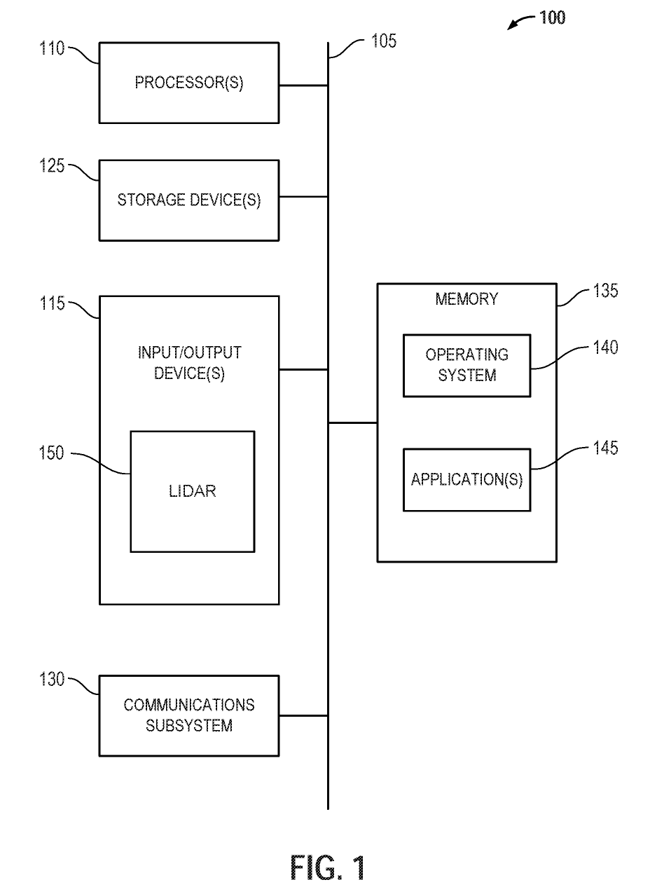

Referring to FIG. 1, an example device 100 adapted for use with a Lidar is shown. The device 100 is shown comprising hardware elements that can be electrically coupled via a bus 105 (or may otherwise be in communication, as appropriate). The hardware elements may include one or more processors 110, including without limitation one or more general-purpose processors and/or one or more special-purpose processors (such as digital signal processing chips, graphics acceleration processors, and/or the like); one or more input/output devices 115 including without limitation a Lidar 150, a mouse, a keyboard, a speaker, a printer, and/or the like. The Lidar 150 may include a hardware Lidar controller.

The device 100 may further include (and/or be in communication with) one or more non-transitory storage devices 125, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The device 100 might also include a communication subsystem 130, which can include without limitation a modem, a network card (wireless or wired), an infrared communication device, a wireless communication device and/or chipset (such as a Bluetooth device, an 802.11 device, a Wi-Fi device, a WiMAX device, cellular communication facilities, etc.), and/or the like. The communications subsystem 130 may permit data to be exchanged with a network, other computer systems/devices, and/or any other devices described herein. In many embodiments, the device 100 will further comprise a working memory 135, which can include a RAM or ROM device, as described above.

The device 100 also can comprise software elements, shown as being currently located within the working memory 135, including an operating system 140, device drivers, executable libraries, and/or other code, such as one or more application programs 145, which may comprise or may be designed to implement methods, and/or configure systems, provided by other embodiments, as described herein. Merely by way of example, one or more procedures described with respect to the method(s) discussed below might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 125 described above. In some cases, the storage medium might be incorporated within a computer device, such as the device 100. In other embodiments, the storage medium might be separate from a computer device (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the device 100 and/or might take the form of source and/or installable code, which, upon compilation and/or installation on the device 100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Embodiments of the disclosure relate to a Lidar comprising a cantilever comprising a piezoelectric element and a fiber optic cable. The piezoelectric element may be actuated to vibrate with a driving signal. The piezoelectric element may be a rigid structure difficult to bend. Electrically actuating the piezoelectric element for two-dimensional movement in orthogonal X- and Y-axes may require a driving signal with a relatively high voltage. A high quality factor (Q factor) of resonance of the cantilever is required to obtain enough displacement at the tip of the fiber optic since the piezoelectric element itself deflects by only a few microns. The high quality factor means that to get the maximum deflection, the vibration frequency of the cantilever—and thus the driving signal frequency—has a small tolerable margin of error. In other words, the driving signal frequency cannot deviate from the resonant frequency of the cantilever by more than a few Hertz (Hz). Moreover, the harmonics in the driving signal must be sufficiently low as not to excite multiple resonant modes.

Hereinafter a system that supplies the driving signals to the piezoelectric element may be referred to as a drive system. Ideally, a drive system should meet the following requirements: 1) it should be compact in size; 2) it should be power-efficient so as to reduce heatsinking requirements; 3) it should have low harmonic distortion in order to prevent excitation of multiple modes of cantilever resonance; and 4) it should be capable of determining the resonant frequency of the cantilever and adjusting the driving signal frequency as close to the resonant frequency as practicable in order to minimize the power needed for driving the cantilever.

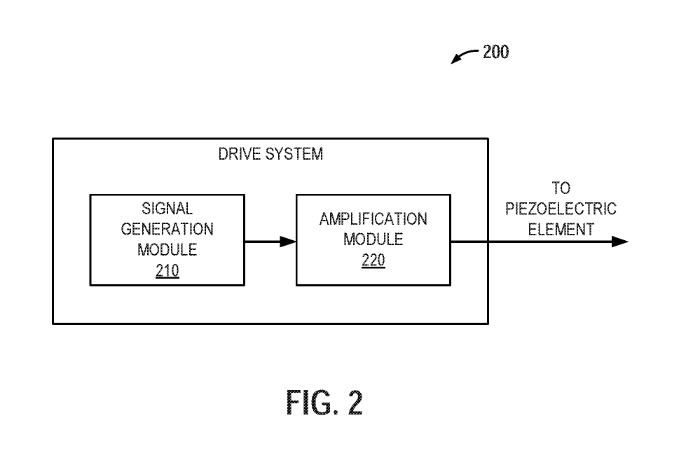

Referring to FIG. 2, a block diagram illustrating an example drive system 200 is shown. The drive system 200 may comprise two modules: a signal generation module 210 and an amplification module 220. The signal generation module 210 may generate a signal with one or more desired characteristics (e.g., a desired frequency, a desired amplitude, etc.). The amplification module 220 may amplify the signal generated by the signal generation module 210 into a driving signal suitable for driving the piezoelectric element.

In different embodiments, the amplification module 220 of the drive system 200 may comprise a Class G or a Class H amplifier. A Class G amplifier is a variation on a standard push-pull amplifier and features more than one supply rails with discrete supply voltage steps. The Class G amplifier switches between the supply rails as needed, depending on the output voltage required. As a typical driving signal is a periodic signal with varying voltages over time, utilizing a Class G amplifier which switches to a lower-voltage supply rail when the output voltage is low may save significant power. A Class G amplifier also has lower or no cutoff distortion when the output voltage is high. Moreover, a Class H amplifier is a variation on a standard push-pull amplifier and is capable of tracking the input signal and modulating the voltage on the one or more supply rails based on the input signal. Techniques such as envelope tracking may be utilized.

In one embodiment, the amplification module 220 may comprise a 5-rail Class G amplifier. The voltages on the supply rails may be +200V, +100V, 0V, −100V, and −200V. Of course, the number of rails and the supply voltages are illustrative and do not limit the disclosure. A typical driving signal may be in the hundreds of volts at its peaks. The piezoelectric element may be a mostly capacitive load at the drive frequency. At the crest of the driving signal, the capacitance of the piezoelectric element needs to be discharged. One advantage of utilizing a multi-rail Class G amplifier is that the energy stored in the piezoelectric element may be discharged to the ground power rail, thereby reducing energy loss.

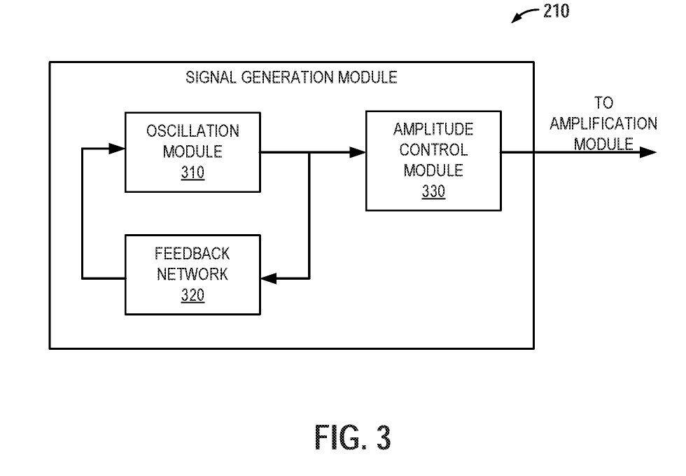

Referring to FIG. 3, a block diagram illustrating an example signal generation module 210 is shown. The signal generation module 210 may comprise an oscillation module 310 and a feedback network 320. In some embodiments, the signal generation module 210 may further comprise an amplitude control module 330. The feedback network 320 may receive an input (not shown) relating to the current two-dimensional position (e.g., the X-axis position and the Y-axis position) of the vibrating cantilever (the piezoelectric element and/or the fiber optic cable). The oscillation module 310 and the feedback network 320 may constitute a phase-locked loop (PLL) that is configured to generate an output signal (which is to be amplified into a driving signal without phase change) whose phase differs from the phase of cantilever vibration by a constant phase difference (e.g., a phase angle). The phase difference to be kept constant may be the difference between the phase of the output signal and the X-axis phase of cantilever vibration (“X-axis phase difference” hereinafter), the difference between the phase of the output signal and the Y-axis phase of cantilever vibration (“Y-axis phase difference” hereinafter), or a (weighted) average of the X-axis and Y-axis phase differences. The selection of the phase angle difference to be kept constant may be to maximize either the X-axis deflection or Y-axis deflection, or to optimize overall power efficiency. A skilled artisan would recognize that different phase differences correspond to different driving signal frequencies.

In different embodiments, the oscillation module 310 may comprise a voltage-controlled oscillator or a direct digital synthesizer further comprising a numerically controlled oscillator. The feedback network 320 may comprise a phase detector/comparator, a low-pass loop filter, an integrator/accumulator, etc. The architecture of a phase-locked loop is well-known in the art. The two-dimensional position of the vibrating cantilever may be detected using a position sensing device (PSD) (such as an optical PSD), a phased array of acoustic transducers, or other mechanisms known in the art.

In order to maximize the power efficiency of the drive system, the frequency of the driving signal should be tightly aligned with the resonant frequency of the cantilever. The resonant frequencies in the X- and Y-axes may be different. For example, the resonant frequency of one axis may be deliberately made higher than the other for the purpose of raster-type scanning. Choosing the optimal driving signal frequency may be further complicated by the fact that the resonant frequency and the quality factor may change with the driving signal amplitude, temperature, aging, barometric pressure, or potentially other factors, etc. The high quality factor of the cantilever (sometimes in the hundreds or possibly even over 1000) may require the driving signal frequency to be within a fraction of a percent of the resonant frequency for optimal power efficiency.

To determine the phase difference corresponding to the resonant frequency, different phase differences between the phase of the output signal from the oscillation module 310 (which is the same as the phase of the driving signal after amplification) and the phase of cantilever vibration may be searched through to find the phase difference that corresponds to the greatest deflection of the fiber optic cable given the same driving signal amplitude. When the resonant frequencies in the X- and Y-axes are different, an X-axis phase difference that corresponds to the X-axis resonant frequency and therefore the greatest X-axis deflection, and a Y-axis phase difference that corresponds to the Y-axis resonant frequency and therefore the greatest Y-axis deflection may be determined separately.

In different embodiments, resonance in the X- and Y-axes may be favored differently. For example, to implement a circular spiral scanning pattern, the average of X-axis and Y-axis resonant frequencies may be chosen as the driving signal frequency. As another example, to implement an elliptical scanning pattern, such as when the Lidar is looking ahead of the path of a vehicle where a wide and short field of view may be desirable, the X-axis resonant frequency may be chosen as the driving signal frequency at the expense of Y-axis resonance, in order to maximize the optic fiber deflection in the X-axis.

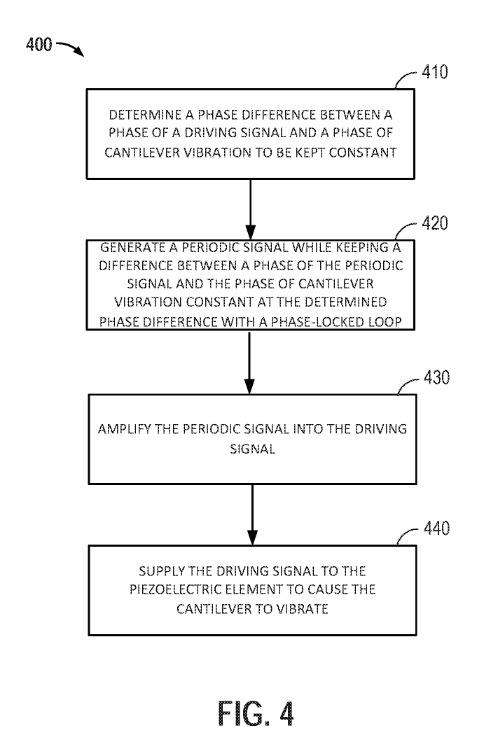

Referring to FIG. 4, a flowchart illustrating an example method 400 for providing a driving signal to a piezoelectric element within a Lidar is shown. At block 410, a phase difference between a phase of the driving signal and a phase of cantilever vibration to be kept constant may be determined, the cantilever comprising the piezoelectric element and a fiber optic cable. At block 420, a periodic signal may be generated while a difference between a phase of the periodic signal and the phase of cantilever vibration is kept constant at the determined phase difference with a phase-locked loop. At block 430, the periodic signal may be amplified into the driving signal. At block 440, the driving signal may be supplied to the piezoelectric element to cause the cantilever to vibrate. Light emitted from the fiber optic cable which deflects as part of the vibrating cantilever may create a scanning pattern.

The determined phase difference may correspond to a driving signal frequency. The determined phase difference may be 1) the difference between the phase of the driving signal and the phase of cantilever vibration along a first axis, 2) the difference between the phase of the driving signal and the phase of cantilever vibration along a second axis orthogonal to the first axis, or 3) a weighted average of 1) and 2). The determined phase difference may 1) maximize deflection of the fiber optic cable along the first axis, 2) maximize deflection of the fiber optic cable along the second axis, 3) optimize overall power efficiency, 4) implement a particular scanning pattern, or 5) satisfy some other criteria. The phase of cantilever vibration may be detected using a position sensing device or a phased array of acoustic transducers. The phase-locked loop may comprise a phase detector and may further comprise a voltage-controlled oscillator or a direct digital synthesizer. The periodic signal may be amplified with a Class G amplifier or a Class H amplifier. The scanning pattern may be a raster-type scanning pattern, a circular spiral scanning pattern, or an elliptical scanning pattern.

One embodiment of the disclosure relates to a device comprising: a Lidar comprising a cantilever comprising a piezoelectric element and a fiber optic cable; a memory; and a processor coupled to the memory, the processor to: determine a phase difference between a phase of a driving signal and a phase of cantilever vibration to be kept constant, generate a periodic signal while keeping a difference between a phase of the periodic signal and the phase of cantilever vibration constant at the determined phase difference with a phase-locked loop, amplify the periodic signal into the driving signal, and supply the driving signal to the piezoelectric element to cause the cantilever to vibrate, wherein light emitted from the fiber optic cable which deflects as part of the vibrating cantilever creates a scanning pattern.

Therefore, embodiments of the disclosure find an optimal phase difference between the phase of the driving signal and the phase of cantilever vibration to be kept constant based on various criteria and generate a driving signal while keeping the phase difference constant with a phase-locked loop. A Class G or Class H amplifier may be utilized in the amplification stage. The overall power efficiency of the drive system may be optimized because the driving signal frequency is kept close to the resonant frequency of the piezoelectric element, and power-efficient amplifiers are used in the amplification stage. Moreover, different desired scanning patterns may be generated by light emitted from the fiber optic cable by either equalizing the fiber optic deflection along two orthogonal axes or by favoring the deflection along one axis over the other.

It should be appreciated that aspects of the disclosure previously described may be implemented in conjunction with the execution of instructions (e.g., applications) by processor 110 of computing device 100, as previously described. Particularly, circuitry of the device, including but not limited to processor, may operate under the control of an application, program, routine, or the execution of instructions to execute methods or processes in accordance with embodiments of the disclosure (e.g., the processes of FIG. 4). For example, such a program may be implemented in firmware or software (e.g., stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc.

Example methods, apparatuses, or articles of manufacture presented herein may be implemented, in whole or in part, for use in or with mobile communication devices. As used herein, “mobile device,” “mobile communication device,” “hand-held device,” “tablets,” etc., or the plural form of such terms may be used interchangeably and may refer to any kind of special purpose computing platform or device that may communicate through wireless transmission or receipt of information over suitable communications networks according to one or more communication protocols, and that may from time to time have a position or location that changes. As a way of illustration, special purpose mobile communication devices, may include, for example, cellular telephones, satellite telephones, smart telephones, heat map or radio map generation tools or devices, observed signal parameter generation tools or devices, personal digital assistants (PDAs), laptop computers, personal entertainment systems, e-book readers, tablet personal computers (PC), personal audio or video devices, personal navigation units, wearable devices, or the like. It should be appreciated, however, that these are merely illustrative examples relating to mobile devices that may be utilized to facilitate or support one or more processes or operations described herein.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described storage media may comprise primary, secondary, and/or tertiary storage media. Primary storage media may include memory such as random access memory and/or read-only memory, for example. Secondary storage media may include mass storage such as a magnetic or solid-state hard drive. Tertiary storage media may include removable storage media such as a magnetic or optical disk, a magnetic tape, a solid-state storage device, etc. In certain implementations, the storage media or portions thereof may be operatively receptive of, or otherwise configurable to couple to, other components of a computing platform, such as a processor.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,” “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general-purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method for providing a driving signal to a piezoelectric element within a Lidar, comprising:
determining a phase difference between a phase of the driving signal and a phase of cantilever vibration to be kept constant, the cantilever comprising the piezoelectric element and a fiber optic cable;
generating a periodic signal while a difference between a phase of the periodic signal and the phase of cantilever vibration is kept constant at the determined phase difference with a phase-locked loop;
amplifying the periodic signal into the driving signal; and
supplying the driving signal to the piezoelectric element to cause the cantilever to vibrate,
wherein light emitted from the fiber optic cable which deflects as part of the vibrating cantilever creates a scanning pattern.

2. The method of claim 1, wherein the determined phase difference corresponds to a driving signal frequency.

3. The method of claim 1, wherein the determined phase difference is one of: 1) a difference between the phase of the driving signal and a phase of cantilever vibration along a first axis, 2) a difference between the phase of the driving signal and the phase of cantilever vibration along a second axis orthogonal to the first axis, or 3) a weighted average of 1) and 2).

4. The method of claim 1, wherein the determined phase difference 1) maximizes deflection of the fiber optic cable along the first axis, 2) maximizes deflection of the fiber optic cable along the second axis, 3) optimizes overall power efficiency, or 4) implements a particular scanning pattern.

5. The method of claim 1, wherein the phase of cantilever vibration is detected using a position sensing device or a phased array of acoustic transducers.

6. The method of claim 1, wherein the phase-locked loop comprises a phase detector and further comprises a voltage-controlled oscillator or a direct digital synthesizer.

7. The method of claim 1, wherein the periodic signal is amplified with a Class G amplifier or a Class H amplifier.

8. The method of claim 1, wherein the scanning pattern is a raster-type scanning pattern, a circular spiral scanning pattern, or an elliptical scanning pattern.

9. A device, comprising:
a Lidar comprising a cantilever comprising a piezoelectric element and a fiber optic cable;
a memory; and
a processor coupled to the memory, the processor to:
determine a phase difference between a phase of a driving signal and a phase of cantilever vibration to be kept constant,
generate a periodic signal while keeping a difference between a phase of the periodic signal and the phase of cantilever vibration constant at the determined phase difference with a phase-locked loop,
amplify the periodic signal into the driving signal, and
supply the driving signal to the piezoelectric element to cause the cantilever to vibrate,
wherein light emitted from the fiber optic cable which deflects as part of the vibrating cantilever creates a scanning pattern.

10. The device of claim 9, wherein the determined phase difference corresponds to a driving signal frequency.

11. The device of claim 9, wherein the determined phase difference is one of: 1) a difference between the phase of the driving signal and a phase of cantilever vibration along a first axis, 2) a difference between the phase of the driving signal and the phase of cantilever vibration along a second axis orthogonal to the first axis, or 3) a weighted average of 1) and 2).

12. The device of claim 9, wherein the determined phase difference 1) maximizes deflection of the fiber optic cable along the first axis, 2) maximizes deflection of the fiber optic cable along the second axis, 3) optimizes overall power efficiency, or 4) implements a particular scanning pattern.

13. The device of claim 9, wherein the phase of cantilever vibration is detected using a position sensing device or a phased array of acoustic transducers.

14. The device of claim 9, wherein the phase-locked loop comprises a phase detector and further comprises a voltage-controlled oscillator or a direct digital synthesizer.

15. The device of claim 9, wherein the periodic signal is amplified with a Class G amplifier or a Class H amplifier.

16. The device of claim 9, wherein the scanning pattern is a raster-type scanning pattern, a circular spiral scanning pattern, or an elliptical scanning pattern.

17. A device for providing a driving signal to a piezoelectric element within a Lidar, comprising:
means for determining a phase difference between a phase of the driving signal and a phase of cantilever vibration to be kept constant, the cantilever comprising the piezoelectric element and a fiber optic cable;
means for generating a periodic signal while a difference between a phase of the periodic signal and the phase of cantilever vibration is kept constant at the determined phase difference with a phase-locked loop;
means for amplifying the periodic signal into the driving signal; and
means for supplying the driving signal to the piezoelectric element to cause the cantilever to vibrate,
wherein light emitted from the fiber optic cable which deflects as part of the vibrating cantilever creates a scanning pattern.

18. The device of claim 17, wherein the determined phase difference corresponds to a driving signal frequency.

19. The device of claim 17, wherein the determined phase difference is one of: 1) a difference between the phase of the driving signal and a phase of cantilever vibration along a first axis, 2) a difference between the phase of the driving signal and the phase of cantilever vibration along a second axis orthogonal to the first axis, or 3) a weighted average of 1) and 2).

20. The device of claim 17, wherein the determined phase difference 1) maximizes deflection of the fiber optic cable along the first axis, 2) maximizes deflection of the fiber optic cable along the second axis, 3) optimizes overall power efficiency, or 4) implements a particular scanning pattern.

21. The device of claim 17, wherein the phase of cantilever vibration is detected using a position sensing device or a phased array of acoustic transducers.

22. The device of claim 17, wherein the phase-locked loop comprises a phase detector and further comprises a voltage-controlled oscillator or a direct digital synthesizer.

23. The device of claim 17, wherein the periodic signal is amplified with a Class G amplifier or a Class H amplifier.

24. A non-transitory computer-readable medium comprising code which, when executed by a processor, causes the processor to perform a method for providing a driving signal to a piezoelectric element within a Lidar, comprising:
determining a phase difference between a phase of the driving signal and a phase of cantilever vibration to be kept constant, the cantilever comprising the piezoelectric element and a fiber optic cable;
generating a periodic signal while a difference between a phase of the periodic signal and the phase of cantilever vibration is kept constant at the determined phase difference with a phase-locked loop;
amplifying the periodic signal into the driving signal; and
supplying the driving signal to the piezoelectric element to cause the cantilever to vibrate,
wherein light emitted from the fiber optic cable which deflects as part of the vibrating cantilever creates a scanning pattern.

25. The non-transitory computer-readable medium of claim 24, wherein the determined phase difference corresponds to a driving signal frequency.

26. The non-transitory computer-readable medium of claim 24, wherein the determined phase difference is one of: 1) a difference between the phase of the driving signal and a phase of cantilever vibration along a first axis, 2) a difference between the phase of the driving signal and the phase of cantilever vibration along a second axis orthogonal to the first axis, or 3) a weighted average of 1) and 2).

27. The non-transitory computer-readable medium of claim 24, wherein the determined phase difference 1) maximizes deflection of the fiber optic cable along the first axis, 2) maximizes deflection of the fiber optic cable along the second axis, 3) optimizes overall power efficiency, or 4) implements a particular scanning pattern.

28. The non-transitory computer-readable medium of claim 24, wherein the phase of cantilever vibration is detected using a position sensing device or a phased array of acoustic transducers.

29. The non-transitory computer-readable medium of claim 24, wherein the phase-locked loop comprises a phase detector and further comprises a voltage-controlled oscillator or a direct digital synthesizer.

30. The non-transitory computer-readable medium of claim 24, wherein the periodic signal is amplified with a Class G amplifier or a Class H amplifier.
